(19) United States
(12) Patent Application Publication
(10) Pub. No.: US 2025/0026391 A1
(43) Pub. Date: Jan. 23, 2025

(54) HANDCART

(71) Applicant: ISUZU MOTORS LIMITED, Yokohama-shi (JP)

(72) Inventor: Hayao KIMURA, Fujisawa-shi (JP)

(21) Appl. No.: 18/752,229

(22) Filed: Jun. 24, 2024

(30) Foreign Application Priority Data
Jul. 20, 2023 (JP) 2023-118402

(51) Int. Cl. B62B 3/02; B62B 5/04

(52) U.S. Cl. CPC B62B 3/02; B62B 5/04; B62B 2206/04; B62B 2206/06; B62B 2301/00

(57) ABSTRACT

The present disclosure provides a handcart that facilitates alignment of a load even when a heavy load is placed. To this end, the handcart includes: a vehicle main body including a wheel on a lower surface and a handle erected on a rear portion; and a platform disposed on an upper surface of the vehicle main body to be movable in a lateral direction.

### CROSS REFERENCE TO RELATED APPLICATIONS

This application is entitled to (or claims) the benefit of Japanese Patent Application No. 2023-118402, filed on Jul. 20, 2023, the disclosure of which including the specification, drawings and abstract is incorporated herein by reference in its entirety.

### TECHNICAL FIELD

The present disclosure relates to a handcart, and more particularly, to a handcart that is easy to load and unload.

### BACKGROUND ART

A conventional handcart, for example, as disclosed in Patent Literature (hereinafter, referred to as “PTL”) 1 includes a plurality of wheels, generally four wheels, on a lower surface of a platform, and is provided with a handle erected on a rear side of the platform. A user moves the handcart to carry a load to a predetermined position by operating the handle, with the load placed on the platform.

### CITATION LIST

### Patent Literature

PTL 1: Japanese Patent Application Laid-Open No. 2021-030739

### SUMMARY OF INVENTION

### Technical Problem

For example, when a battery is mounted on a handcart and carried to a mounting section of a vehicle in order to mount the battery on the mounting section, it is necessary to align the mounting section with the battery while the battery is mounted on the handcart. In a conventional handcart, it is necessary to perform the alignment by operating a handle of the handcart to move the handcart. Since larger batteries weigh several hundred kilograms, it is very difficult to align the mounting section with the battery together with the handcart.

An object of the present disclosure is to provide a handcart that can facilitate alignment of a load even when loaded with a heavy load.

### Solution to Problem

A handcart of the present disclosure includes: a vehicle main body including a wheel on a lower surface and a handle erected on a rear portion; and a platform disposed on an upper surface of the vehicle main body to be movable in a lateral direction.

### Advantageous Effects of Invention

According to a handcart of the present disclosure, it is possible to easily align a load without operating a handcart.

### BRIEF DESCRIPTION OF DRAWINGS

FIG. 1 is a trimetric projection (front) of a handcart;

FIG. 2 is a trimetric projection (rear) of the handcart;

FIG. 3 is a bottom view of the handcart;

FIG. 4 is a trimetric projection illustrating a principal part of a platform and a lock mechanism;

FIG. 5 is a trimetric projection illustrating the lock mechanism;

FIG. 6 is a side view of the lock mechanism;

FIG. 7 is a plan view of a state in which the platform is in a neutral position;

FIG. 8 is a plan view of a state in which the platform is moved to the left;

FIG. 9 is a plan view illustrating an operation of mounting a battery on the vehicle;

FIG. 10 is a plan view illustrating the operation of mounting the battery on the vehicle;

FIG. 11 is a plan view illustrating the operation of mounting the battery on the vehicle;

FIG. 12 is a plan view illustrating the operation of mounting the battery on the vehicle;

FIG. 13 is a trimetric projection illustrating an operation of unloading the battery from the vehicle;

FIG. 14 is a trimetric projection illustrating the operation of unloading the battery from the vehicle;

FIG. 15 is a trimetric projection illustrating the operation of unloading the battery from the vehicle;

FIG. 16 is a trimetric projection illustrating the operation of unloading the battery from the vehicle; and

FIG. 17 is a trimetric projection illustrating the operation of unloading the battery from the vehicle.

### DESCRIPTION OF EMBODIMENTS

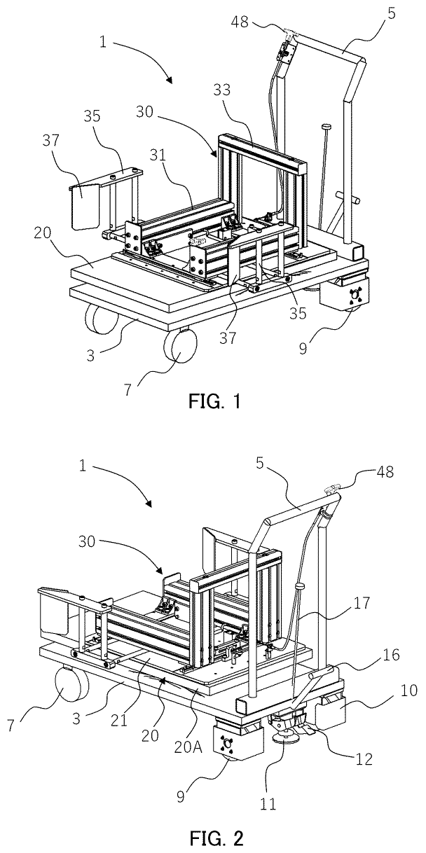

Hereinafter, a handcart according to an embodiment of the present disclosure will be described with reference to the drawings. Note that, in the present specification, the direction in which a handcart travels by a user pushing a handle is described as a front direction, the opposite direction is described as a rear direction, and the left-right direction with respect to the front direction is described as a lateral direction. In FIG. 1, handcart 1 includes vehicle main body 3, handle 5 erected in the rear of vehicle main body 3, fixed wheels 7 disposed in the front of the lower surface of vehicle main body 3, and omni-directional wheels 9 disposed in the rear of the lower surface of vehicle main body 3. Handle 5 is formed in a gate shape from a pair of left and right pillars erected on the rear portion of vehicle main body 3 and a handlebar extending between the pair of left and right pillars. Fixed wheels 7 are wheels whose direction is fixed in the front-rear direction. Omni-directional wheels 9 are wheels called omni-wheels or mechanum wheels that can be moved in the front, rear, left, and right directions without changing the direction of the wheels. In the present embodiment, the omni-wheels are used as omni-directional wheels 9.

In FIG. 2, covers 10 are disposed in the rear of vehicle main body 3 so as to surround omni-directional wheels 9 in order to prevent a foot of the user from making contact with omni-directional wheels 9. Covers 10 are plate-shaped members formed so as to cover around omni-directional wheels 9. In addition, stopper 11 for preventing movement of handcart 1 is disposed at the center of the rear portion of vehicle main body 3. Stopper 11 is configured to be raised and lowered with respect to vehicle main body 3 so as to be positioned above the lower ends of omni-directional wheels 9 in the raised position and protrude below the lower ends of omni-directional wheels 9 in the lowered position. A front end portion of lever 12 is pivotally supported so as to be movable up and down with respect to vehicle main body 3, and an intermediate portion thereof is pivotally attached to stopper 11. Further, the rear end portion of lever 12 is formed in a flat plate shape so as to be able to perform a pedaling operation.

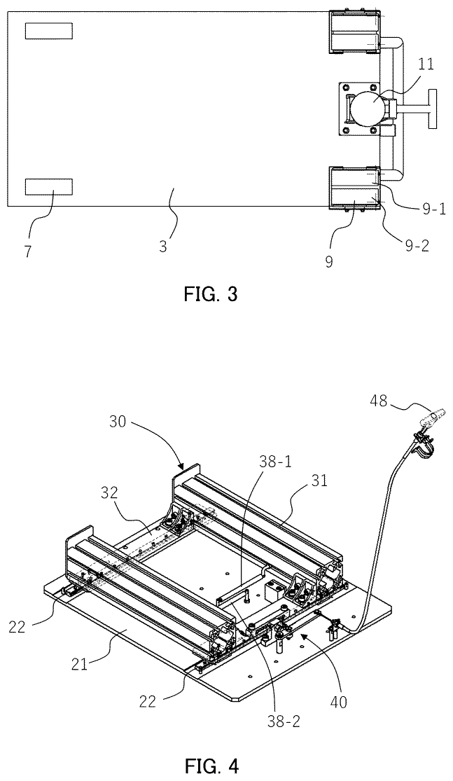

FIG. 3 is a bottom view of handcart 1. The pair of left and right fixed wheels 7 are disposed in the front (the left side in the figure) of vehicle main body 3, and the pair of left and right omni-directional wheels 9 are disposed in the rear (the right side in the figure) of vehicle main body 3. In the illustrated example, omni-directional wheels 9 are a pair of left and right omni-wheels, each of which is composed of two omni-directional wheels 9-1 and 9-2. That is, there are a total of four omni-directional wheels. Stopper 11 is disposed between left and right omni-directional wheels 9.

As illustrated in FIGS. 1 and 2, lifting table 20 is disposed on vehicle main body 3, so as to be movable up and down via a lifting member such as a link mechanism. By depressing lifting foot pedal 16, lifting table 20 is lifted in accordance with the number of times of depression. Further, the lifting table is lowered by twisting lowering twist handle 17. Lifting table 20 includes lifting-table main body 20A and base member 21 disposed on the upper surface of the lifting-table main body. A pair of front and rear guide rails 22 (see FIG. 4) are disposed on the upper surface of base member 21 in the lateral direction. Platform 30 is disposed on guide rails 22 so as to be movable in the lateral direction along guide rails 22.

Platform 30 includes a pair of left and right lower frame members 31 disposed along the front-rear direction, a pair of front and rear coupling members 32 disposed along the lateral direction and connecting left and right lower frame members 31, gate-shaped rear frame member 33 erected on the rear end portions of lower frame members 31, and a pair of left and right side frame members 35 disposed to extend laterally outward and perpendicularly from lower frame members 31. Further, a pair of left and right guide members 37 spreading out forward are disposed on the front portions of side frame members 35. A pair of springs 38-1 and 38-2 stretched beyond the natural length are disposed in a stretched state between base member 21 and the pair of lower frame members 31, and platform 30 is biased to a neutral position at the center of base member 21 in the lateral direction.

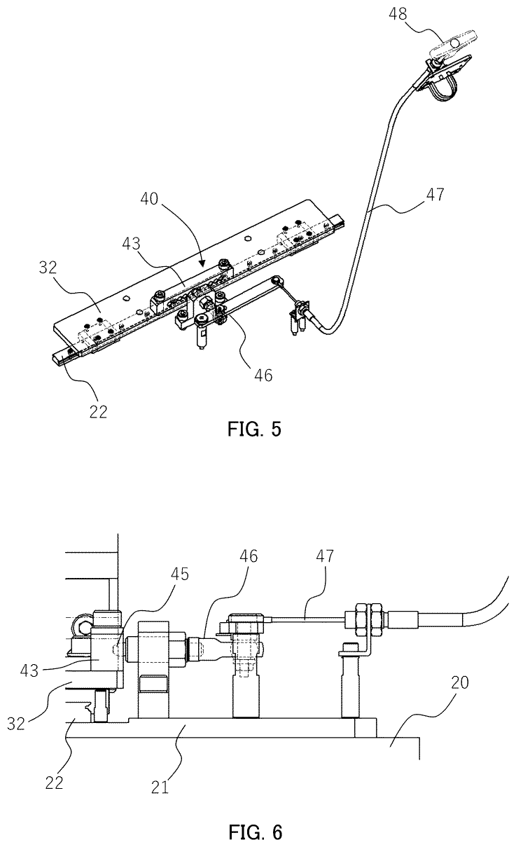

As illustrated in FIGS. 4 to 6, lock mechanism 40 for locking the movement of platform 30 is provided between base member 21 and platform 30. Coupling member 32 on the rear side of platform 30 is provided with lock hole member 43. In lock hole member 43, a plurality of lock holes which are opened toward the rear side are formed in lateral alignment. On the other hand, base member 21 is provided with lock pin 45 enterable in the lock holes such that the lock pin is advanceable and retractable toward and from the front. Lock pin 45 is biased forward by a biasing means such as a spring (not illustrated). One end portion of cable 47 is connected to lock pin 45 via link mechanism 46. Release lever 48 is connected to the other end portion of cable 47, and release lever 48 is attached to an upper portion of handle 5. When the user pulls release lever 48, lock pin 45 is pulled backward against the biasing force of the biasing means via cable 47 and link mechanism 46, and is withdrawn out of the lock holes. When the user releases release lever 48, lock pin 45 is advanced forward by the biasing force of the biasing means and is inserted into the lock holes.

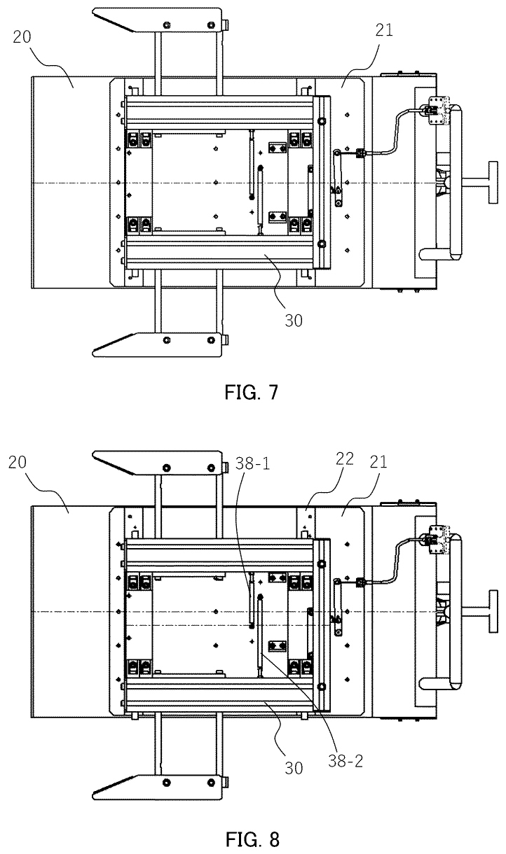

Next, the operation of handcart 1 will be described. FIG. 7 illustrates platform 30 in a neutral position in the lateral center with respect to base member 21. In a state where lock pin 45 is pulled out of the lock holes by operating release lever 48, platform 30 is held in the neutral position by the biasing forces of springs 38-1 and 38-2.

When a lateral force is applied to platform 30 and/or a load placed thereon, platform 30 moves laterally against the biasing forces of springs 38-1 and 38-2. In FIG. 8, due to a leftward external force applied, a biasing force acts in a direction (rightward direction) in which spring 38-1 is compressed, spring 38-2 extends, and spring 38-2 contracts. When release lever 48 is released in this state, the position of platform 30 is fixed by lock mechanism 40. When lock mechanism 40 is released and further the external force is removed, platform 30 returns to the neutral position in the lateral center due to the contraction force of spring 38-2.

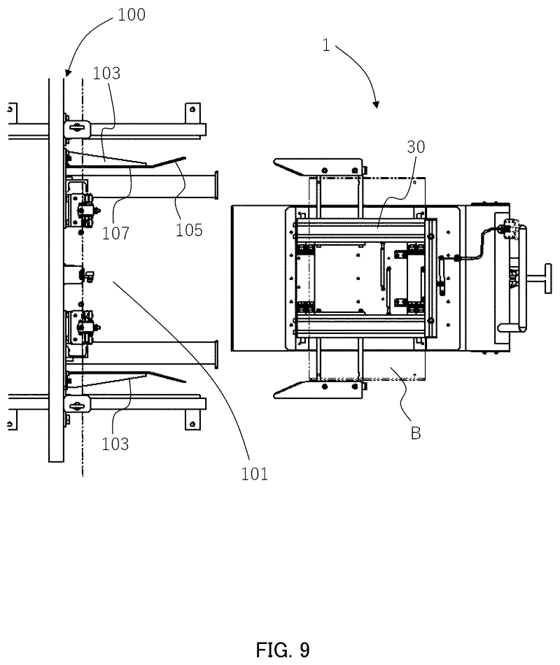

FIGS. 9 to 12 illustrate a procedure of mounting battery B as a load on mounting section 101 of vehicle 100 using handcart 1. Note that regarding vehicle 100, only the periphery of mounting section 101 on which battery B is mounted is illustrated. Mounting section 101 is, on the left and right sides, provided with guide walls 103 for guiding battery B. Guide walls 103 are formed from tapered portions 105 formed in a tapered shape so as to narrow from the front side (vehicle outer side) toward the farther side (vehicle inner side), and straight portions 107 extending in parallel from the front side toward the farther side. FIG. 9 illustrates a state in which handcart 1 in which battery B is placed on platform 30 is moving toward mounting section 101 of vehicle 100 on the left side in the figure. At this time, the position of platform 30 is fixed to the lateral center by lock mechanism 40. Handcart 1 and battery B approach mounting section 101 in a state of being slightly shifted to the left side with respect to the center of mounting section 101.

When the direction of handcart 1 is inclined with respect to mounting section 101, the user swings handle 5 to the left and right to adjust the direction. When the user swings handle 5 to the left and right, the rear portion of handcart 1 is swung to the left and right, and the direction of handcart 1 can be easily adjusted, since the rear wheels are omni-directional wheels 9. Whereas a general swivel caster (a caster that can swivel around a vertical swivel axis) inevitably causes friction between the wheels and the floor surface when the wheels swivel around the swivel axis during a lateral movement, omni-directional wheels 9 can also roll in the lateral direction and fine adjustment in the lateral direction can thus be easily performed.

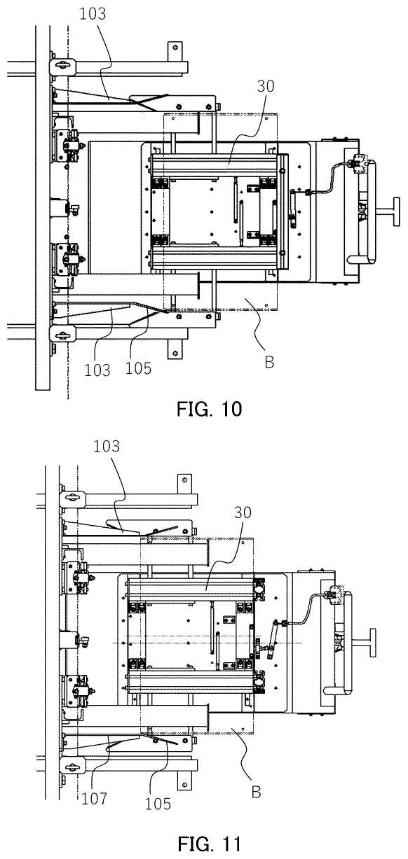

FIG. 10 illustrates a state in which the handcart is closer to vehicle 100. At this time, battery B comes into contact with tapered portion 105 of guide wall 103 on the left side as seen from the battery side, but has a gap from guide wall 103 on the right side. Then, the user operates release lever 48 to release lock mechanism 40.

FIG. 11 illustrates the state in which handcart 1 is further advanced. When handcart 1 is advanced following the state of FIG. 10, the front left corner of battery B advances while being guided by left tapered portion 105, and battery B together with platform 30 thus moves to the right side with respect to vehicle main body 3, and is laterally aligned with respect to mounting section 101. Lateral alignment between battery B and mounting section 101 is performed by the user only advancing handcart 1 without steering.

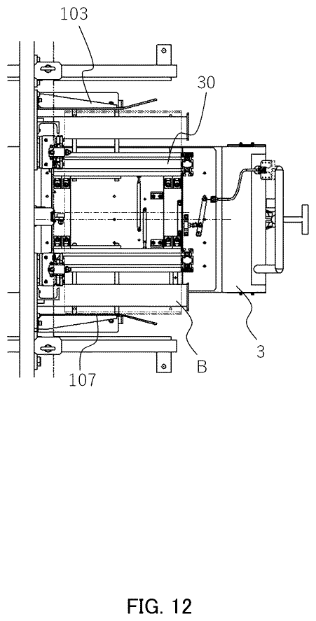

FIG. 12 illustrates the state in which handcart 1 is further advanced. Battery B is advanced to a farther predetermined position while being guided by left and right straight portions 107. Also at this time, battery B is positioned at the predetermined position of mounting section 101 by the user only advancing handcart 1.

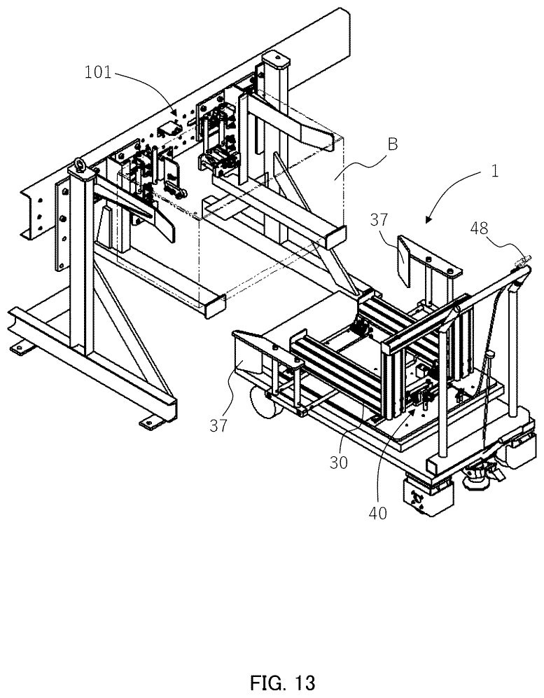

FIGS. 13 to 17 illustrate the operation of handcart 1 performed when battery B mounted on mounting section 101 is unloaded. FIG. 13 illustrates a state in which handcart 1 approaches battery B mounted on mounting section 101. At this time, it is not necessary to accurately align the center line of handcart 1 with battery B. The user moves handcart 1 forward toward mounting section 101 in a state in which lock mechanism 40 is released by operating release lever 48.

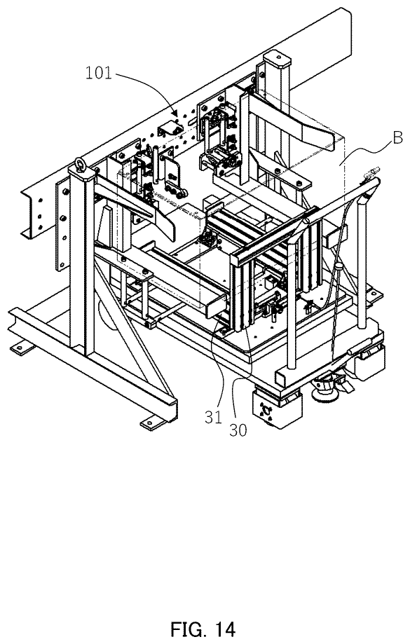

Next, as illustrated in FIG. 14, handcart 1 is advanced until lower frame members 31 of platform 30 are positioned below battery B. At this time, guide members 37 of platform 30 are guided in contact with battery B, and platform 30 thus moves in the lateral direction, such that alignment between the center of battery B and the center of platform 30 in the lateral direction takes place.

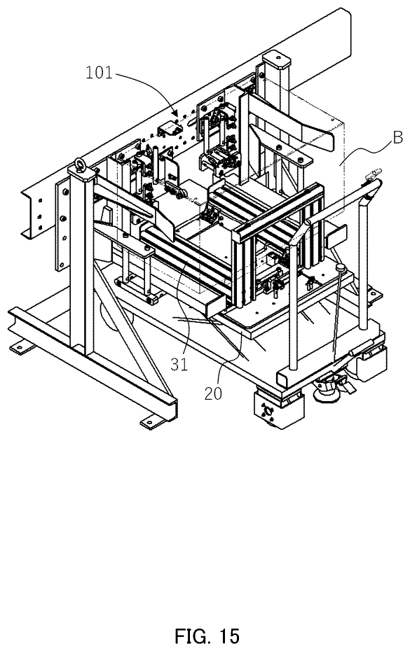

Next, as illustrated in FIG. 15, lifting table 20 is lifted to bring lower frame members 31 of platform 30 into contact with the lower surface of battery B, and further lifted to raise lift battery B. Then, battery B is raised apart from mounting section 101.

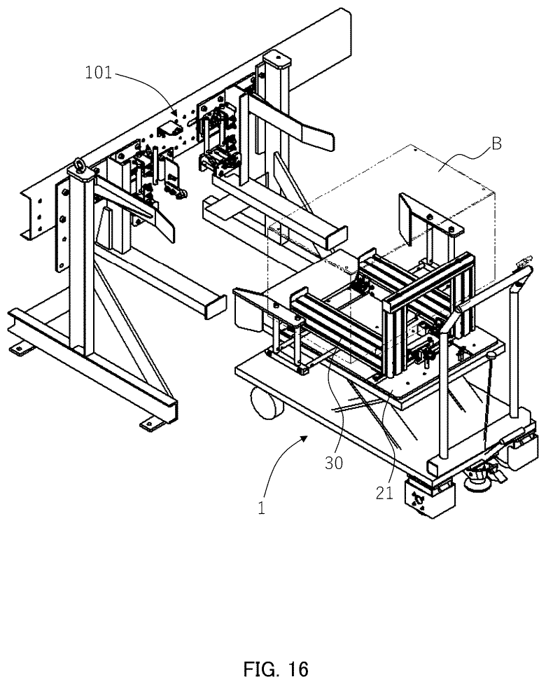

Next, as illustrated in FIG. 16, handcart 1 is retracted, and battery B is detached from mounting section 101. When battery B is detached from mounting section 101, platform 30 returns to the neutral position in the lateral center with respect to base member 21 by the biasing forces of springs 38-1 and 38-2. Then, the user releases release lever 48 to lock lock mechanism 40, and locks the position of platform 30 to stabilize platform 30.

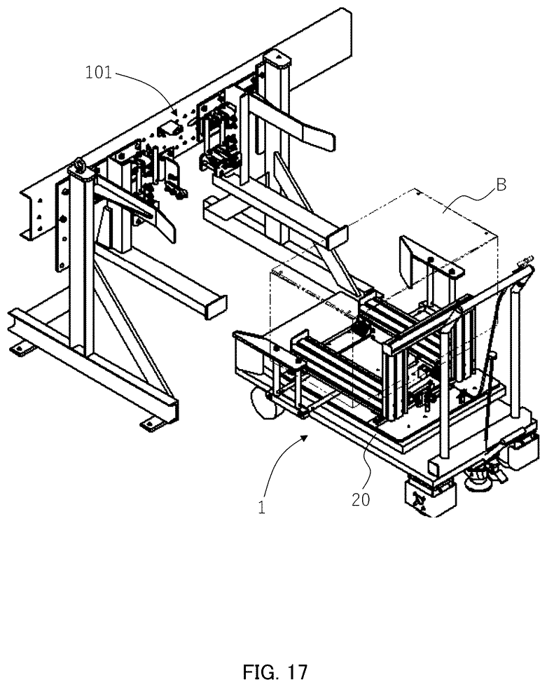

Finally, as illustrated in FIG. 17, lifting table 20 is lowered to complete detachment of battery B from mounting section 101.

Although the above description has been made along with the embodiment, the handcart of the present disclosure is not limited to the above embodiment in any way. In the embodiment, the platform is disposed on the lifting table, but the platform may be disposed directly on the vehicle main body. In addition, it is needless to say that the present invention can be appropriately modified within the scope specified in the claims.

### INDUSTRIAL APPLICABILITY

The present invention can be suitably applied to a handcart that carries a load.

### REFERENCE SIGNS LIST

1 Handcart
3 Vehicle main body
5 Handle
7 Fixed wheel
9 Omni-directional wheel (omni-wheel)
10 Cover
11 Stopper
12 Lever
20 Lifting table
21 Base member
22 Guide rail
30 Platform
31 Lower frame member
32 Coupling member
33 Rear frame member
35 Side frame member
37 Guide member
38-1 Spring (right)
38-2 Spring (left)
40 Lock mechanism
43 Lock hole member
45 Lock pin
46 Link mechanism
47 Cable
48 Release lever
100 Vehicle
103 Guide wall
105 Tapered portion
107 Straight portion
B Load (Battery)

1. A handcart, comprising:
a vehicle main body including a wheel on a lower surface and a handle erected on a rear portion; and
a platform disposed on an upper surface of the vehicle main body to be movable in a lateral direction.

2. The handcart according to claim 1, further comprising:
a lock mechanism for locking movement of the platform in the lateral direction.

3. The handcart according to claim 2, wherein
the lock mechanism includes a lock hole formed in the platform, a lock pin disposed on the vehicle main body and enterable in the lock hole, a biasing member for biasing the lock pin such that the lock pin enters in the lock hole, and an operation member for operating the lock pin in a direction in which the lock pin retracts out of the lock hole against a biasing force of the biasing member.

4. The handcart according to claim 1, wherein:
the vehicle main body is provided with a guide rail along the lateral direction, and
the platform is guided on the guide rail in the lateral direction.

5. The handcart according to claim 1, further comprising:
a lifting table disposed to be movable up and down with respect to the vehicle main body, wherein
the platform is disposed so as to be movable in the lateral direction with respect to the lifting table.

6. The handcart according to claim 5, wherein:
the lifting table is provided with a guide rail along the lateral direction, and
the platform is guided on the guide rail in the lateral direction.

7. The handcart according to claim 1, wherein:
the platform is provided with a pair of left and right guide members spreading out forward.

8. The handcart according to claim 1, further comprising:
a biasing member for biasing the platform toward a center in the lateral direction.

9. The handcart according to claim 8, wherein
the biasing member is an elastic member.

10. The handcart according to claim 1, wherein
the wheel includes front wheels including a pair of left and right fixed wheels, and rear wheels including a pair of left and right omni-directional wheels,

11. The handcart according to claim 10, further comprising:
a pair of left and right omni-directional wheels on an intermediate portion of the vehicle main body in a front-rear direction.
